(19) United States
(12) Patent Application Publication
(10) Pub. No.: US 2016/0187249 A1
(43) Pub. Date: Jun. 30, 2016

(54) DETECTIVE DEVICE AND DETECTIVE METHOD

(71) Applicants: Industrial Technology Research Institute, Hsinchu (TW); Chang Gung Memorial Hospital, Linkou, Taoyuan (TW)

(72) Inventors: Sheng-Po Wang, Taoyuan County (TW); Heng-Yin Chen, Hsinchu County (TW); Chien-Ju Lee, Taoyuan County (TW); Pai-Chien Chou, New Taipei City (TW)

(21) Appl. No.: 14/586,961

(22) Filed: Dec. 31, 2014

(51) Int. Cl. G01N 21/25; G01N 21/59

(52) U.S. Cl. CPC G01N 21/25; G01N 21/5907

(57) ABSTRACT

A detective method for detecting a condition of a biochemical sample is provided. A first reference value and a second reference value are obtained. A biochemical sample may be irradiated with a first wavelength light, and the first wavelength light that has passed through the biochemical sample is received by a light sensor, so that a first measured value is obtained. The biochemical sample may be irradiated with a second wavelength light, and the light sensor receives the second wavelength light that has passed through the biochemical sample, so that a second measured value is obtained. The first measured value may be compared with the first reference value so that a first treatment is performed, and the second measured value may be compared with the second reference value so that a second treatment is performed. A detective device is also provided.

### TECHNICAL FIELD

The technical field relates to a detective device and a detective method. The technical field relates to a detective device and a detective method for detecting condition of a biochemical sample.

### BACKGROUND

Cell culture is an important technique in basic biological and medical research. Generally, cells are cultured in culture dishes containing a culture medium, the cell culture medium is periodically replaced and the cells are subjected to subculture. Since cells grow, proliferate and produce metabolites all the time, and might be infected with, for example, virus or bacteria during the culture process, periodical and intensive observation of condition of cells is an important step in cell culture.

Current cell culture mainly relies on manual operation. However, growth state and proliferation rate of cells may vary with variation in time and environment, and unexpected events such as infection of cells and deterioration of a culture medium might occur. Accordingly, it is hard for an operator to make real-time determination and treatment in response to a variation in the culture medium. In addition, calculation of cell density is also a complicated step for the operator. Therefore, an automated instrument capable of providing assistance in determining condition of the cells will be favorable for improvement in quality and efficiency of cell culture.

### SUMMARY

According to an exemplary embodiment of the disclosure, a detective device that detects condition of a biochemical sample is provided for obtaining real-time condition of a biochemical sample.

According to an exemplary embodiment of the disclosure, a detective method is also provided for obtaining real-time condition of a biochemical sample.

The detective device according to an exemplary embodiment of the disclosure is configured to detect condition of a biochemical sample. The detective device includes a carrier, a first light source, a second light source, a light sensor and a control element. The carrier is configured to carry a biochemical sample. The first light source emits a first wavelength light to irradiate the biochemical sample at a first time point. The second light source emits a second wavelength light to irradiate the biochemical sample at a second time point. The light sensor is configured to receive the first wavelength light and the second wavelength light that have passed through the biochemical sample, so as to obtain a first measured value and a second measured value respectively. The control element has stored therein a first reference value and a second reference value of the light sensor corresponding to the first wavelength light and the second wavelength light respectively, for comparing the first reference value with the first measured value and comparing the second reference value with the second measured value.

The detective method according to an exemplary embodiment of the disclosure is configured to detect condition of a biochemical sample. The detective method includes the following steps. A first reference value and a second reference value are obtained. A biochemical sample is irradiated with a first wavelength light, and the first wavelength light that has passed through the biochemical sample is received by a light sensor, so that a first measured value is obtained. The biochemical sample is irradiated with a second wavelength light, and the second wavelength light that has passed through the biochemical sample is received by the light sensor, so that a second measured value is obtained. The first measured value is compared with the first reference value, so that a first treatment is performed. The second measured value is compared with the second reference value, so that a second treatment is performed.

Based on the above, the detective device and the detective method according to the disclosure irradiate a biochemical sample with lights of different colors at different times, thereby facilitating detection of different characteristics of the biochemical sample. In this way, by summarizing the obtained characteristics of the biochemical sample, the condition of the biochemical sample is determined precisely and instantly.

Several exemplary embodiments accompanied with figures are described in detail below to further describe the disclosure in details.

### BRIEF DESCRIPTION OF THE DRAWINGS

FIG. 1A is a schematic view of a detective device according to an exemplary embodiment of the disclosure.

FIG. 1B is a schematic view of a light sensor of a detective device according to an exemplary embodiment of the disclosure.

FIG. 2 is a flow chart of a detective method according to an exemplary embodiment of the disclosure.

FIG. 3 is a flow chart of a detective method according to an exemplary embodiment of the disclosure.

FIG. 4 is a flow chart of a detective method according to an exemplary embodiment of the disclosure.

FIG. 5 is a flow chart of a detective method according to an exemplary embodiment of the disclosure.

FIG. 6 is a flow chart of a detective method according to an exemplary embodiment of the disclosure.

FIG. 7 is a schematic view of a detection and treatment system according to an exemplary embodiment of the disclosure.

FIG. 8A are photographs of cell culture media of Sample 1 to Sample 8 of a present experimental example; FIG. 8B is a line chart of OD values of the cell culture media under irradiation with a first wavelength light and a second wavelength light respectively, the OD values being measured by a spectrophotometer.

FIGS. 9A to 9D are schematic views of a method for determining a first state according to an exemplary embodiment of the disclosure.

FIGS. 10A and 10B are schematic views showing principles of a method for determining a second state according to an exemplary embodiment of the disclosure.

### DETAILED DESCRIPTION OF DISCLOSED EMBODIMENTS

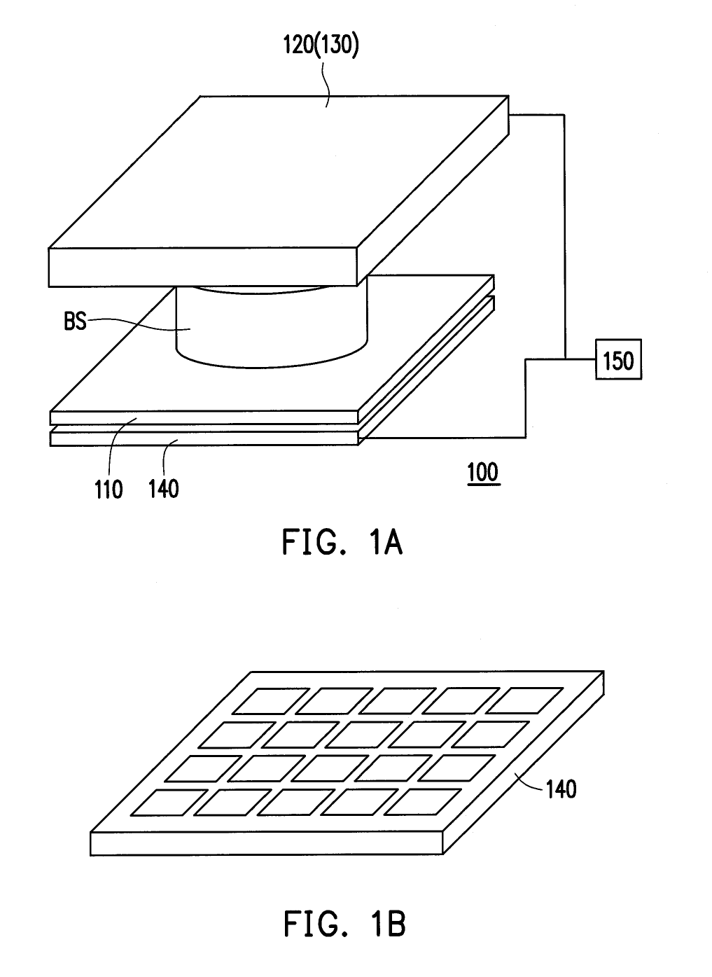

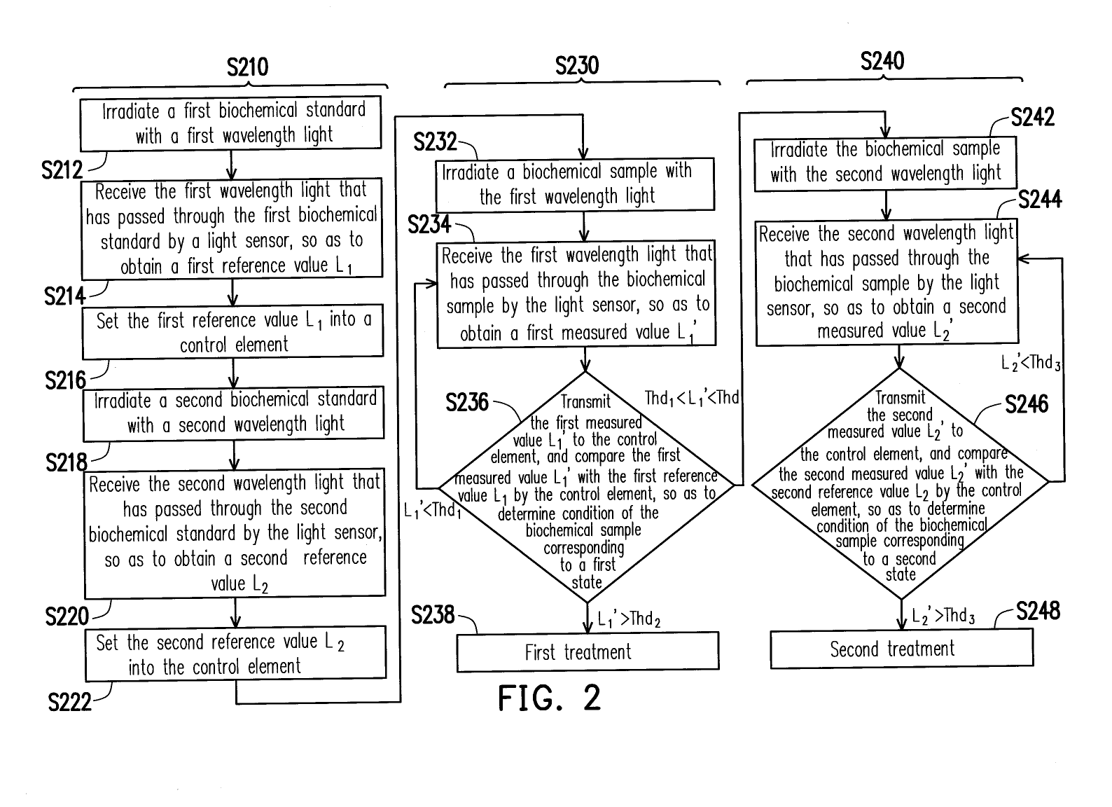

FIG. 1A is a schematic view of a detective device according to an exemplary embodiment of the disclosure. A detective device 100 is configured to detect condition of a biochemical sample. The detective device 100 includes a carrier 110, a first light source 120, a second light source 130, a light sensor 140 and a control element 150. The carrier 110 is configured to carry a biochemical sample BS. The carrier 110 includes, for example, a light transmissive material such as plastics or glass, etc. The biochemical sample BS includes a culture medium and a culture. The culture is, for example, a cell or protein, which is placed in a carrier dish and cultured in the culture medium or suspended in a solution. The culture medium is, for example, a colored or colorless light transmissive liquid. In addition, the culture medium usually changes color with a change in pH. Therefore, deterioration of the culture medium itself or excessive metabolites or infection of the cell could cause a color change in the culture medium. If the culture medium is DMEM, for example, the culture medium changes color, for example, from pink to orange, as the pH changes. In addition, as the cell content or protein content increases, an overall transmittance of the biochemical sample BS is reduced.

The first light source 120 emits a first wavelength light to irradiate the biochemical sample BS at a first time point. The second light source 130 emits a second wavelength light to irradiate the biochemical sample BS at a second time point. That is, the first light source 120 and the second light source 130 respectively irradiate the biochemical sample BS at different times. The second wavelength light and the first wavelength light are different. In the present exemplary embodiment, the first wavelength light has a wavelength range of, for example, 600 nm to 780 nm, and is, for example, a red light. The second wavelength light has a wavelength range of, for example, 400 nm to 600 nm, and is, for example, a green light or a yellow light. In the present exemplary embodiment, the biochemical sample BS is, for example, placed between the first light source 120 and the light sensor 140 and between the second light source 130 and the light sensor 140. In detail, the first light source 120 and the second light source 130 are, for example, disposed above the biochemical sample BS, while the light sensor 140 is disposed below the biochemical sample BS. In this way, the light emitted from the first light source 120 or the second light source 130 is detected by the light sensor 140 after the light has passed through the biochemical sample BS. The first light source 120 and the second light source 130, for example, irradiate the same portion of the biochemical sample BS. In the present exemplary embodiment, the first light source 120 and the second light source 130 are substantially the same light source, which is switched to emit the first wavelength light or the second wavelength light by adjusting the wavelength. However, the disclosure is not limited hereto. For example, in other exemplary embodiments, the first light source 120 and the second light source 130 may be two different members, and the light source is moved to above the biochemical sample BS by rotation or other means, so that the first light source 120 and the second light source 130 irradiate the same portion of the biochemical sample BS. In addition, the present exemplary embodiment gives an example in which the first light source 120 and the second light source 130 are provided right above the biochemical sample BS. However, the first light source 120 and the second light source 130 substantially may be disposed at any positions that enable the first light source 120 and the second light source 130 to irradiate the biochemical sample BS. For example, lateral irradiation may be performed by the first light source 120 and the second light source 130 respectively, and the light sensor 140 senses intensity of the light that has passed through the biochemical sample BS. Of course, in other exemplary embodiments, the first light source 120 and the second light source 130 may irradiate different portions of the biochemical sample BS according to needs. It is noted that in the present exemplary embodiment, the culture medium is DMEM, and the first light source 120 and the second light source 130 adopt red light and green light respectively in response to the pink color and orange color of the culture medium caused by change in the pH. However, in other exemplary embodiments, the wavelength ranges of the first and second wavelength lights may be adjusted according to color changes due to different biochemical samples, so as to implement a detective method of the disclosure.

The light sensor 140 is configured to receive the first wavelength light and the second wavelength light that have passed through the biochemical sample BS, so as to obtain a first measured value and a second measured value respectively. In the present exemplary embodiment, the light sensor 140, for example, has different responses to lights of different wavelengths. Moreover, response intensity of the light sensor 140 to the second wavelength light is, for example, higher than to the first wavelength light. In the present exemplary embodiment, the light sensor 140 is, for example, a single sensor (as shown in FIG. 1A) or an array-type sensor (as shown in FIG. 1B), wherein the array-type sensor is configured to calculate an area of a distribution region of a biochemical sample, and is, for example, an amorphous selenium active pixel sensor (a-Se APS). In another exemplary embodiment, the light sensor 140 is a thin-film transistor device, a CCD, a CMOS, a photodiode or the like.

The light sensor 140 converts the light source that has passed through the biochemical sample BS into an electric signal. In the present exemplary embodiment, the light sensor 140 is, for example, disposed below the carrier 110. However, the disclosure is not limited hereto. For example, in another exemplary embodiment, the light sensor is disposed by being incorporated into the carrier.

The control element 150 is configured to receive the first measured value and the second measured value from the light sensor 140, and has stored therein a first reference value and a second reference value of the light sensor corresponding to the first wavelength light and the second wavelength light respectively. Accordingly, the control element 150 compares the first measured value with the first reference value and compares the second measured value with the second reference value, and outputs results of the comparison. In the present exemplary embodiment, the control element 150 is, for example, further connected to the first light source 120 and the second light source 130 so as to control the first light source 120 or the second light source 130 to irradiate the biochemical sample BS.

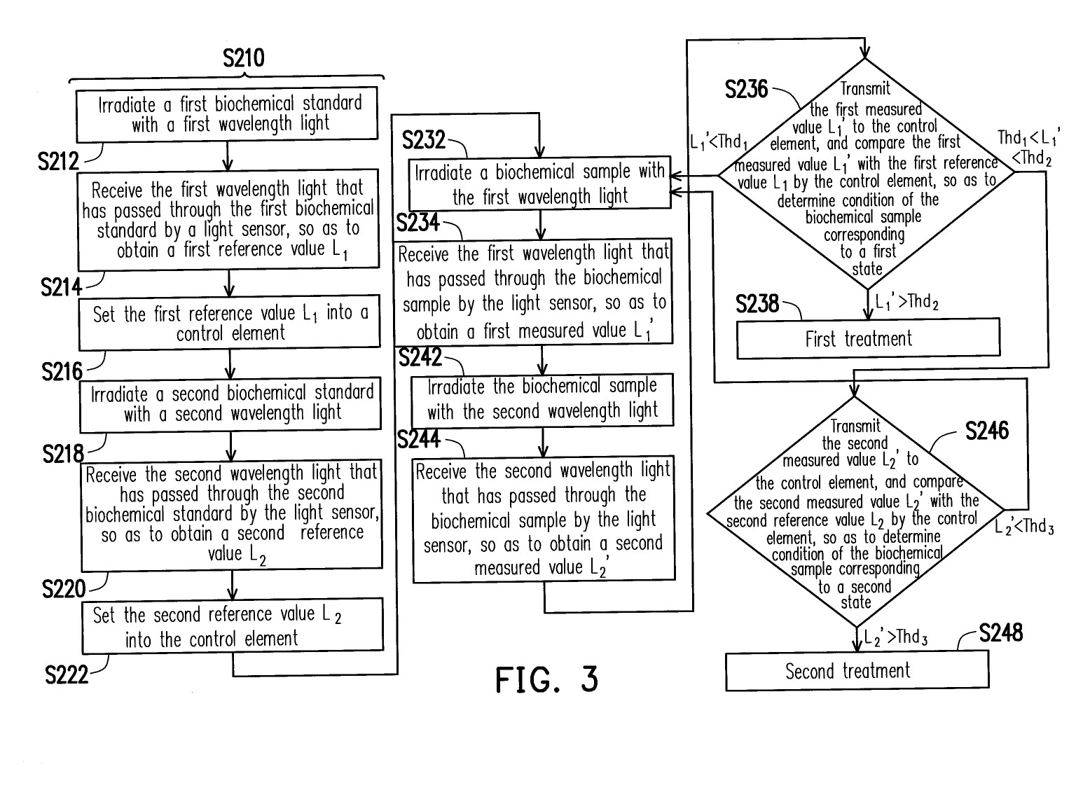

A detective method of the disclosure is described with reference to a detective device. FIG. 2 is a flow chart of a detective method according to an exemplary embodiment of the disclosure. Referring to FIGS. 1A and 2 together, first, a correction step (step S210) is performed on the light sensor 140. The correction step includes two phases. The first phase is to set up a first reference value of a biochemical sample in a first state corresponding to a first wavelength light, and the second phase is to set up a second reference value of the biochemical sample in a second state corresponding to a second wavelength light, wherein the first and second reference values are determined according to density, concentration, quantity, area of a distribution region, pH or color of the biochemical sample. A first biochemical exemplary standard in the first state is provided. The first biochemical exemplary standard is, for example, a DMEM culture medium that appears pink. The first biochemical exemplary standard is irradiated with the first wavelength light (step S212). The first wavelength light that has passed through the first biochemical exemplary standard is received by the light sensor 140, so that a first reference value L₁ is obtained (step S214). Then, the first reference value L₁ is set into the control element 150 (step S216). The first wavelength light has a wavelength range of, for example, 600 nm to 780 nm.

A second biochemical exemplary standard in the second state is provided. The second biochemical exemplary standard includes, for example, a DMEM culture medium changed to orange due to deterioration of the culture medium or infection of the culture. The second biochemical exemplary standard is irradiated with the second wavelength light (step S218). The second wavelength light that has passed through the second biochemical exemplary standard is received by the light sensor 140, so that a second reference value L₂ is obtained (step S220). Then, the second reference value L₂ is set into the control element 150 (step S222). The second wavelength light has a wavelength range of, for example, 400 nm to 600 nm.

After the above correction step is performed on the light sensor 140, a detection step with respect to the first wavelength light may be performed on a biochemical sample by using the light sensor 140 (step S230). In detail, a biochemical sample BS is irradiated with the first wavelength light (step S232). The first wavelength light that has passed through the biochemical sample BS is received by the light sensor 140, so that a first measured value L₁′ is obtained (step S234). The first measured value L₁′ is transmitted to the control element 150, and the control element 150 compares the first measured value L₁′ with the first reference value L₁, so as to determine a condition of the biochemical sample BS corresponding to the first state (step S236). In the present exemplary embodiment, the first measured value L₁′ increases as cell density increases. A comparison method may be to directly compare the first measured value L₁′ with the first reference value L₁, or to calculate a value OD₁, wherein OD₁=L₁/L₁′. When the first measured value L₁′ is smaller than the first reference value L₁, i.e., L₁′<L₁, the control element 150 issues a signal indicating that the culturing of the biochemical sample BS is to be continued. This signal is, for example, transmitted to the first light source 120, so that the biochemical sample BS will be irradiated again with the first wavelength light after a specified time interval, and the biochemical sample BS is thereby monitored. When the first measured value L₁′ is greater than the first reference value L₁, i.e., L₁′>L₁, the control element 150 issues a signal indicating that the biochemical sample BS is to be immediately subjected to, for example, a subculturing process and so on. This signal is, for example, transmitted to a treatment unit for performing a first treatment (step S238).

For example, when the culture in the biochemical sample BS is a cell, the first reference value L₁ may be threshold cell density. If the first measured value L₁′ exceeds the first reference value L_{I}, it means that the cell may be subjected to a subculturing process. Moreover, the first reference value L₁ may be a numerical value directly read by the light sensor 140 or a calculated ratio, wherein the calculated ratio may be advantageous for eliminating difference in background values such as error of machines. In addition, by adjusting density of the culture in the first biochemical exemplary standard and repeating step S214, a plurality of first reference values are generated. For example, the first biochemical exemplary standard may be the culture density of 50%, 60% or 70% with which the culture may continue to grow so that a plurality of corresponding first reference values are obtained, or the first biochemical exemplary standard may be the culture density of 80%, 90% or 100% with which the culture may be immediately subculturing so that a plurality of corresponding first reference values are obtained.

In step S240, a detection step with respect to the second wavelength light is performed on the biochemical sample BS by using the light sensor 140 (step S240). In detail, the biochemical sample BS is irradiated with the second wavelength light (step S242). The second wavelength light that has passed through the biochemical sample BS is received by the light sensor 140, so that a second measured value L₂′ is obtained (step S244). The second measured value L₂′ is transmitted to the control element 150, and the control element 150 compares the second measured value L₂′ with the second reference value L₂, so as to determine a condition of the biochemical sample BS corresponding to the second state (step S246). In the present exemplary embodiment, the second measured value L₂′ decreases as a degree of color change in the culture medium increases. A comparison method may be to directly compare the second measured value L₂′ with the second reference value L₂, or to calculate a value OD₂, wherein OD₂=L₂/L₂′. When the second measured value L₂′ is smaller than the second reference value L₂, i.e., L₂′<L₂, the control element 150 determines that the biochemical sample BS will be irradiated again with the second wavelength light after a specified time interval, and the biochemical sample BS is thereby monitored. When the second measured value L₂′ is greater than the second reference value L₂, i.e., L₂′>L₂, the control element 150 issues a signal indicating that the biochemical sample BS requires replacement of the culture medium, addition of a pharmaceutical agent in the culture medium, or disposal of the cell, and so on. This signal is, for example, transmitted to the treatment unit for performing a second treatment (step S248). The second reference value L₂ may be a numerical value directly read by the light sensor 140 or a calculated ratio, wherein the calculated ratio may be advantageous for eliminating difference in background values such as error of machines

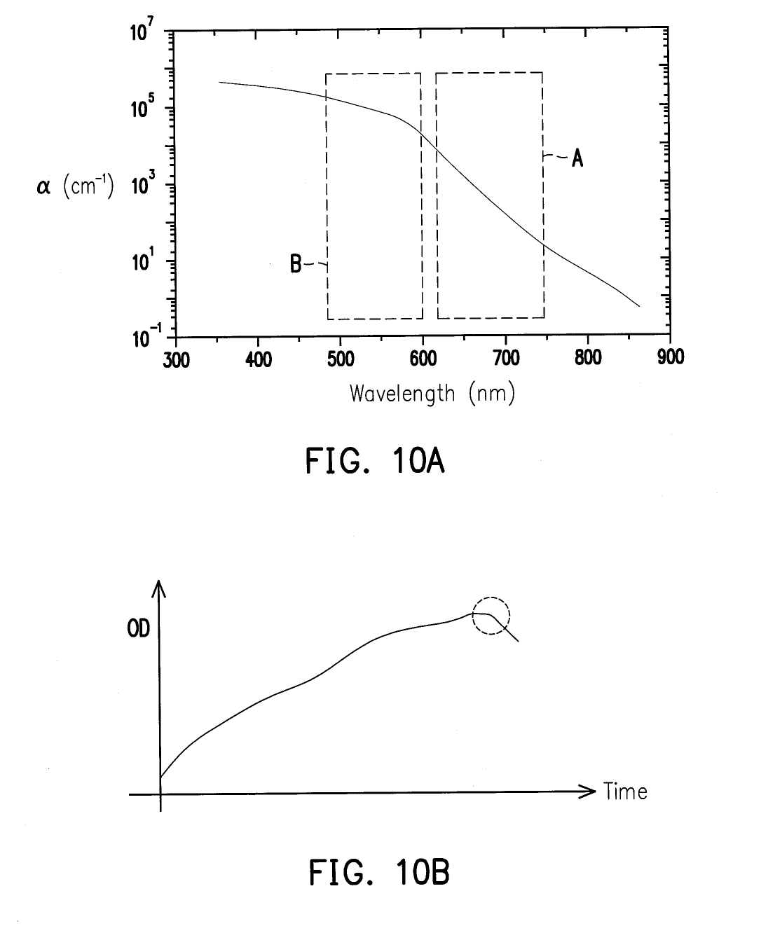

In one exemplary embodiment, as shown in FIG. 10A, the response intensity (region B) of the light sensor 140 to the second wavelength light is higher than the response intensity (region A) to the first wavelength light. Therefore, according to a variation trend in intensity of received light, the condition of the biochemical sample corresponding to the second state is determined Namely, whether the culture medium has undergone a color change is known. For example, as shown in FIG. 10B, when a measured brightness value increases, the absorbance (OD) increases slower, or even decreases instead (as shown by a dashed-line circle). It may be reasonably inferred that the reason therefor is that the spectrum has shifted to the region of the light sensor 140 that has higher response intensity, which means that the culture medium has undergone a color change.

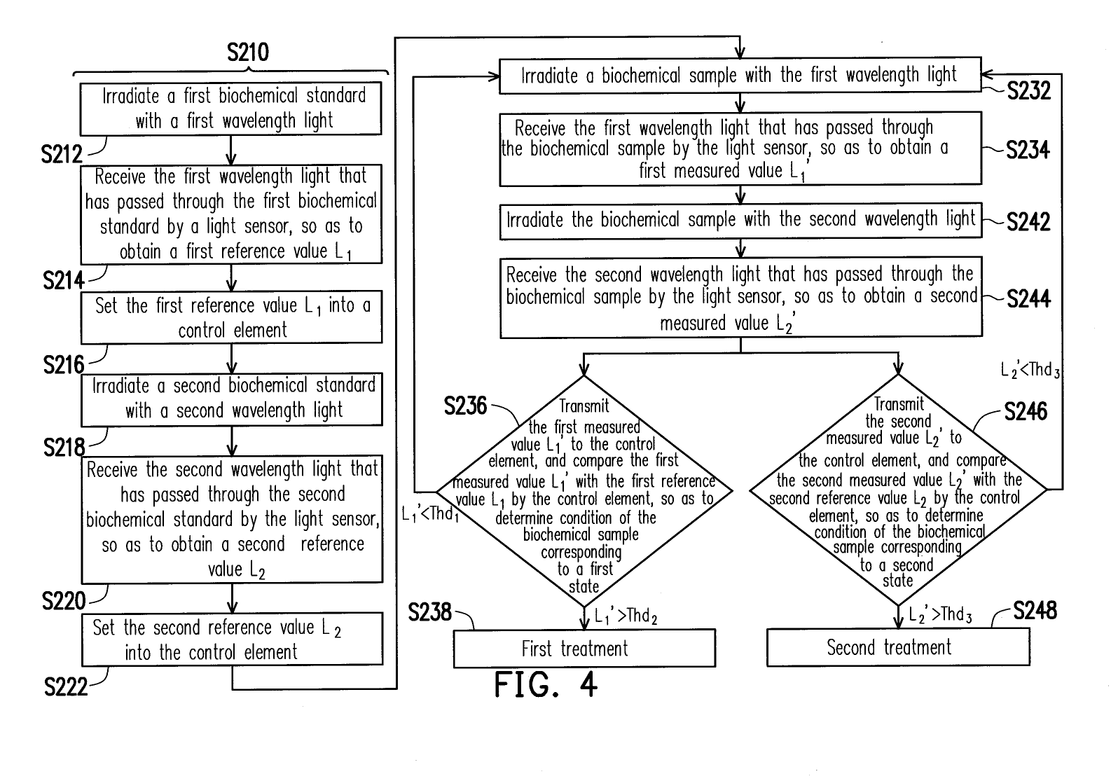

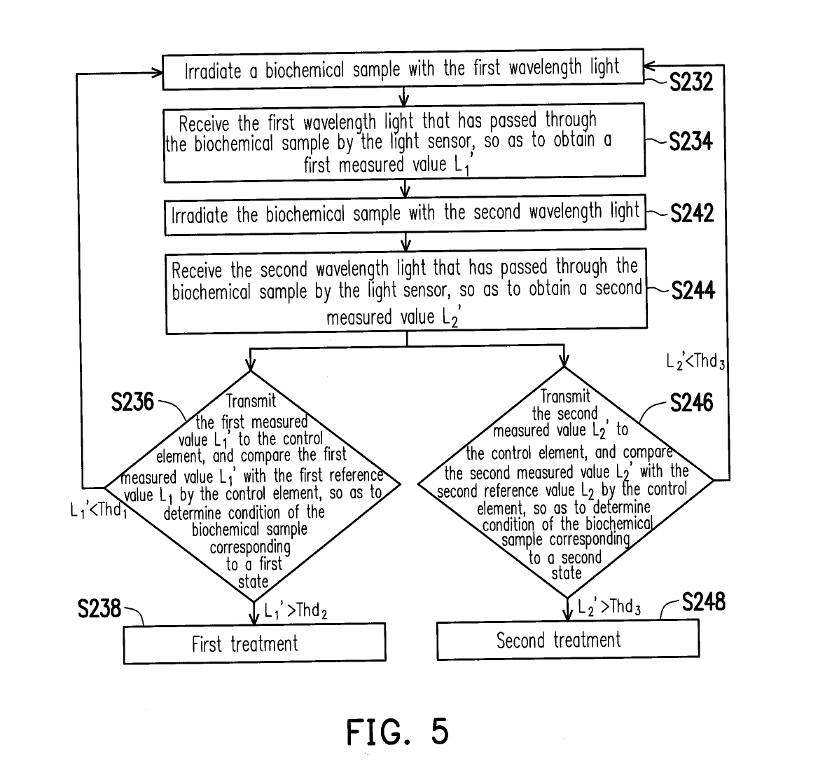

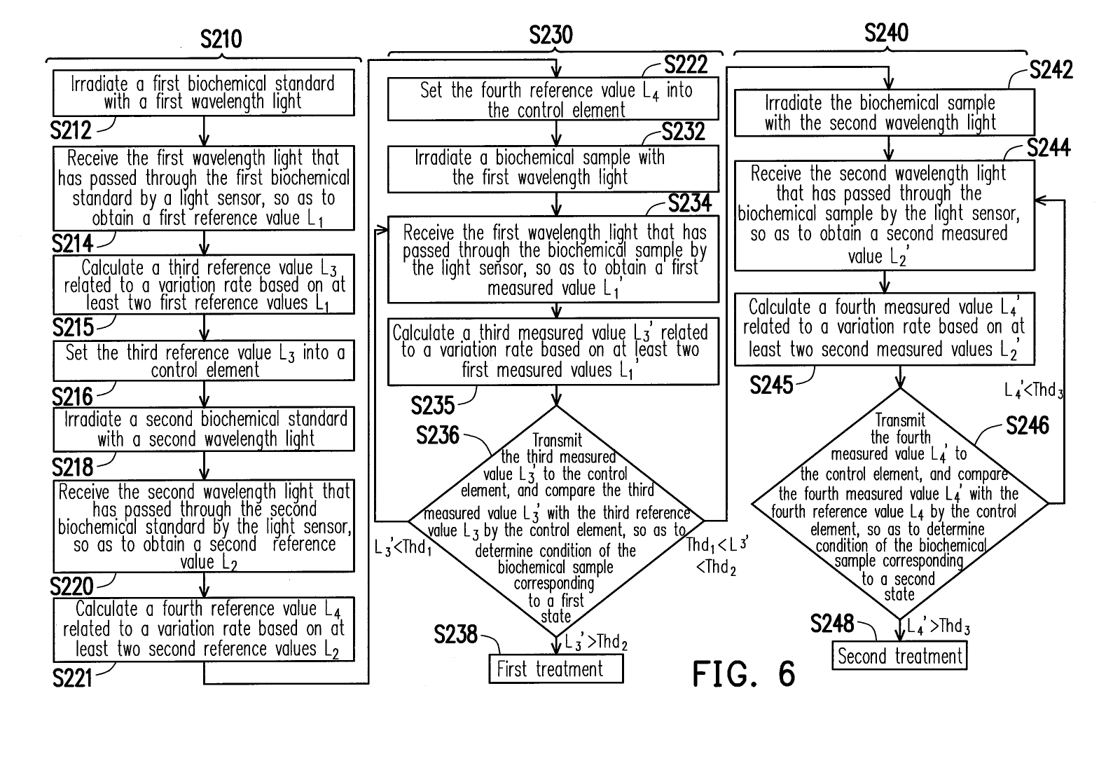

It should be noted that the disclosure does not limit the order of the aforementioned steps. For example, as shown in FIG. 3, the first and second measured values of the biochemical sample BS may be obtained first (i.e., steps S232, S234 and S242, S244), then the condition of the biochemical sample BS corresponding to the first and second states is determined (i.e., steps S236 and S246), and finally, the corresponding first and second treatments are performed on the biochemical sample BS (i.e., steps S238 and S248). In one embodiment, as shown in FIG. 4, the first and second measured values of the biochemical sample BS may be obtained first (i.e., steps S232, S234 and S242, S244), and then the determination and treatment steps (i.e., steps S236 and S246) may be performed separately or concurrently. In one exemplary embodiment, the detection steps (i.e., steps S242 and S244) and the treatment step (i.e., S246) may be performed first, and then the detection steps (i.e., S232 and S234) and the treatment step (i.e., S236) are performed. Moreover, in one exemplary embodiment, as shown in FIG. 5, the operations (i.e., step S210) may have been built into the detective device and thus step S210 may be omitted.

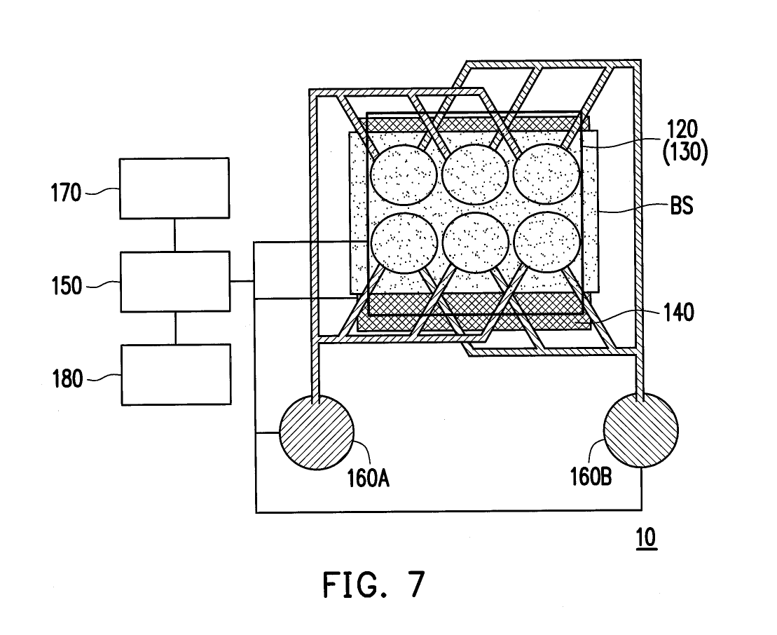

In one exemplary embodiment, as shown in FIG. 6, a predetermined third reference value L₃ is obtained (step S215). The third reference value L₃ is a variation rate obtained by continuously measuring the first reference value L₁ over a certain period of time. The third reference value L₃ is compared with a variation rate (i.e., a third measured value L₃′) of a plurality of the first measured values L₁′, so that a variation rate of the biochemical sample BS corresponding to the first state is determined (step S235). The third measured value L₃ may be a threshold cell growth rate. In detail, a predetermined third reference value L₃ is obtained by measuring the first reference value L₁ twice at at least two different time points. Similarly, a predetermined fourth reference value L₄ is obtained (step S221). The fourth reference value L₄ is a variation rate obtained by continuously measuring the second reference value L₂ over a certain period of time. The fourth reference value L₄ is compared with a variation rate (i.e., a fourth measured value L₄′) of a plurality of the second measured values L₂′, so that a variation rate of the biochemical sample BS corresponding to the second state is determined. In detail, a predetermined fourth reference value L₄ is obtained by measuring the second reference value L₂ twice at at least two different time points. The fourth reference value L₄, for example, represents a threshold rate of color change in the culture medium. Therefore, if the fourth reference value L₄ is exceeded, it means that, for example, the color of the culture medium has changed too fast and the culture medium may be immediately replaced. It is to be noted that, as stated above, the disclosure does not limit the order of the aforementioned steps. Hence, the steps of obtaining the third reference value L₃, the fourth reference value L₄, the third measured value L₃′ and the fourth measured value L₄′ may be combined with the steps shown in FIGS. 3 to 5.

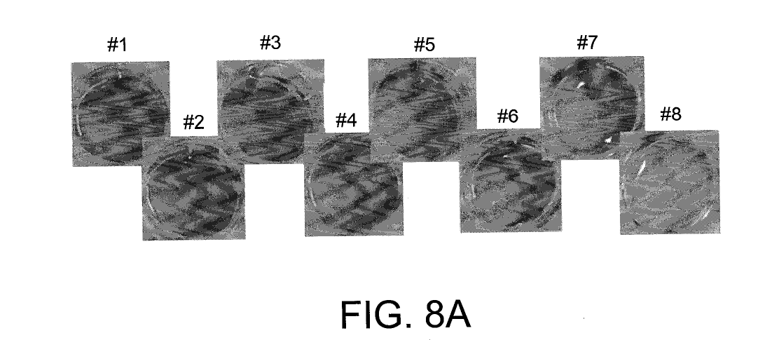

FIG. 7 is a schematic view of a detection and treatment system according to an exemplary embodiment of the disclosure. Referring to FIG. 7, a detection and treatment system 10 incorporates the aforementioned detective device 100 shown in FIGS. 1A and 1B and may be applied to the aforementioned detective method. The detection and treatment system 10 includes the first light source 120, the second light source 130, the light sensor 140 and the control element 150, a first treatment unit 160A, a second treatment unit 160B, a display element 170 and a power supply 180. The control element 150 is connected to the first light source 120, the second light source 130 and the light sensor 140, and details thereof may be understood from the previous exemplary embodiment and will not be repeated herein. In the present exemplary embodiment, the control element 150 is, for example, connected to the display element 170. The display element 170 is, for example, a display panel or a display having an alarm clock function, for displaying a comparison result in the form of a text message on the panel or for producing a warning sound, so as to provide the condition of the biochemical sample BS to an operator.

In the present exemplary embodiment, the control element 150 is, for example, further connected to a treatment unit (such as the first treatment unit 160A and the second treatment unit 160B). According to determination results for the biochemical sample BS with respect to the first and second states, the control element 150 instructs the treatment unit to perform treatments such as subculturing, replacement of the culture medium, addition of a pharmaceutical agent, or disposal, etc. on the biochemical sample BS. In the present exemplary embodiment, the first treatment addresses the problem of an excessive number of cells. The control element 150 may issue a message asking for subculturing, or removal, or replacement of the medium, wherein the replacement of the medium includes water absorption performed by the first treatment unit 160A and injection of water or a pharmaceutical agent performed by the second treatment unit 160B. The second treatment addresses the problem of color change. The control element 150 may issue a message instructing the first treatment unit 160A or the second treatment unit 160B to automatically perform relevant treatments.

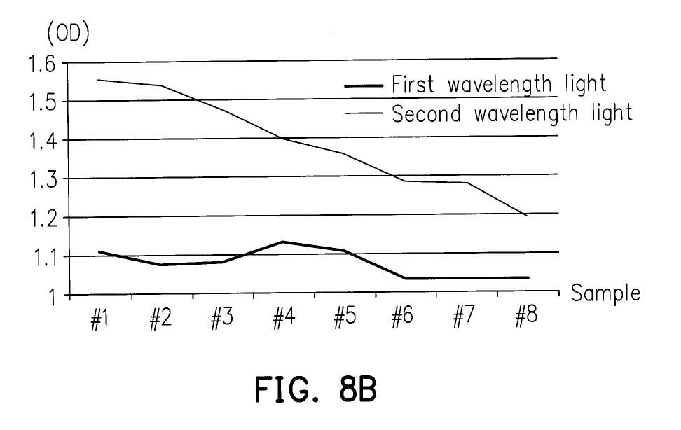

Next, an experimental example illustrates that the second wavelength light of the disclosure may be used for detecting a color change in a cell culture medium. FIG. 8A are photographs of cell culture media of Sample 1 to Sample 8 of the present experimental example; FIG. 8B is a line chart of OD values of the cell culture media under irradiation with a first wavelength light and a second wavelength light respectively, the OD values being measured by a spectrophotometer. The color of the cell culture media changes from pink to yellow in the order from Sample 1 to Sample 8, wherein the culture media are DMEM, no cell is placed in Sample 1 to Sample 8, and the different colors are caused by variation in pH. The first wavelength light has a wavelength range of 600 nm to 780 nm, and the second wavelength light has a wavelength range of 400 nm to 600 nm. Referring to FIGS. 8A and 8B together, from this experimental example, it is known that when the color of the cell culture medium changes in the same manner as shown in Sample 1 to Sample 8, the OD values of the cell culture media with respect to the first wavelength light are roughly the same, while an abrupt decrease occurs in the OD values with respect to the second wavelength light. That is, by combination of the first and second wavelength lights, the color change in the cell culture medium may be retrieved.

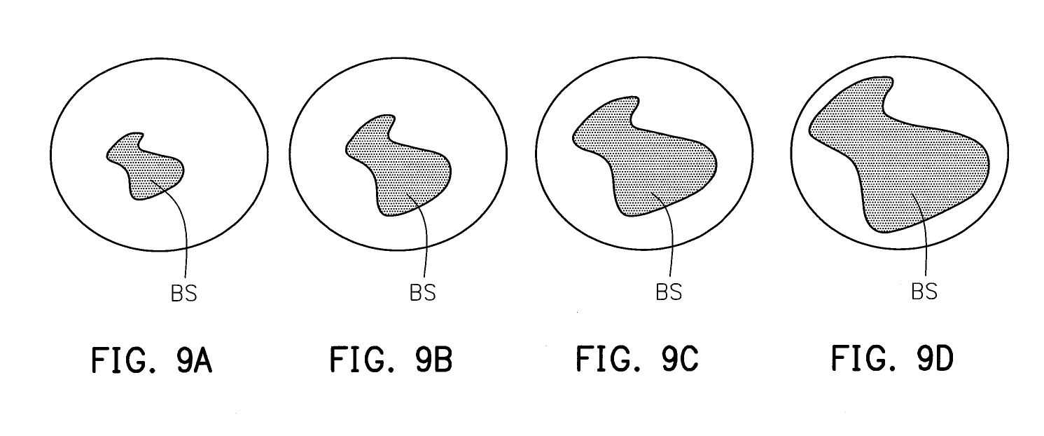

It is particularly noted that although the first state and the second state in the aforementioned exemplary embodiments are differentiated based on the color of the culture medium, the disclosure is not limited hereto. The first state and the second state include density, concentration, quantity, and area of a distribution region (for example, as shown in FIGS. 9A to 9D, wherein FIG. 9D indicates that subculturing may be required) of a biochemical sample, and pH or color of a culture medium that cultures the biochemical sample. In other words, the light sensor may be widely used for detecting several optics-related characteristics of the biochemical sample. In addition, the aforementioned exemplary embodiments give an example in which the biochemical sample is first subjected to detection of cell density, followed by detection of condition of the culture medium. However, the disclosure is also not limited to such order. In addition, the aforementioned exemplary embodiments give an example with lights of two wavelengths. However, in other exemplary embodiments, lights of two or more wavelengths may be used, i.e., detection of two or more characteristics is possible.

In summary, the detective device and the detective method according to the disclosure irradiate the biochemical sample with the lights of different colors at different times, thereby respectively detecting different characteristics of the biochemical sample. In one exemplary embodiment, the response intensity of the light sensor to the first wavelength light and the second wavelength light is greater, and that is, the light sensor has better sensitivity to these two kinds of lights. Further, detecting ability of the light sensor with respect to specific characteristics of the biochemical sample is improved. In this way, by summarizing the obtained characteristics of the biochemical sample, condition of the biochemical sample may be determined more precisely and instantly, and appropriate treatments may be performed on the biochemical sample.

For example, since growth state and proliferation rate of cells may vary with changes in time and environment, and unexpected events such as infection of the cells and deterioration of the culture medium might occur, it is hard for the operator to make real-time determination and treatment in response to a variation in the culture medium.

If the detective device according to an exemplary embodiment of the disclosure is used, it will be easy to monitor cell density and color of the culture medium, so as to obtain condition of the cell. This will conduce to significant improvement in quality and efficiency of cell culture. Of course, the disclosure may further be widely applied in other biochemistry-related techniques, such as being applied in a western blot method for detecting protein concentration. Consequently, research tools in the biochemistry field are improved. In other words, the disclosure may be applied for detection of various optics-related characteristics of a biochemical sample, thereby facilitating obtaining or monitoring of condition of the biochemical sample.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A detective device configured to detect a condition of a biochemical sample, comprising:
a carrier configured to carry the biochemical sample;
a first light source, emitting a first wavelength light to irradiate the biochemical sample at a first time point;
a second light source, emitting a second wavelength light to irradiate the biochemical sample at a second time point;
a light sensor configured to receive the first wavelength light and the second wavelength light that have passed through the biochemical sample, so as to generate a first measured value and a second measured value respectively; and
a control element having stored therein a first reference value of the biochemical sample in a first state and a second reference value of the biochemical sample in a second state, for comparing the first measured value with the first reference value and comparing the second measured value with the second reference value.

2. The detective device according to claim 1, wherein the first reference value corresponds to density, concentration, quantity, area of a distribution region, pH or color of the biochemical sample in the first state, and the second reference value corresponds to density, concentration, quantity, area of a distribution region, pH or color of the biochemical sample in the second state.

3. The detective device according to claim 1, wherein response intensity of the light sensor to the second wavelength light is higher than to the first wavelength light.

4. The detective device according to claim 1, wherein the light sensor generates a plurality of the first measured value and a plurality of the second measured value respectively, and the control element further comprises a third reference value and a fourth reference value for comparing the third reference value with a variation rate of the first measured values and comparing the fourth reference value with a variation rate of the second measured values.

5. The detective device according to claim 1, wherein the biochemical sample comprises a culture medium and a culture, and the culture is a cell or protein.

6. The detective device according to claim 1, wherein the light sensor is an array-type sensor configured to calculate an area of a distribution region of the biochemical sample.

7. The detective device according to claim 2, wherein a wavelength of the first wavelength light corresponds to color of the biochemical sample in the first state, and a wavelength of the second wavelength light corresponds to color of the biochemical sample in the second state.

8. A detective method configured to detect a condition of a biochemical sample, comprising:
obtaining a first reference value and a second reference value;
irradiating the biochemical sample with a first wavelength light, and receiving the first wavelength light that has passed through the biochemical sample by a light sensor, so as to obtain a first measured value;
irradiating the biochemical sample with a second wavelength light, and receiving the second wavelength light that has passed through the biochemical sample by the light sensor, so as to obtain a second measured value;
comparing the first measured value with the first reference value to perform a first treatment; and
comparing the second measured value with the second reference value to perform a second treatment.

9. The detective method according to claim 8, wherein the method of obtaining the first reference value comprises irradiating a first biochemical exemplary standard with the first wavelength light, and receiving the first wavelength light that has passed through the first biochemical exemplary standard by the light sensor; and the method of obtaining the second reference value comprises irradiating a second biochemical exemplary standard with the second wavelength light, and receiving the second wavelength light that has passed through the second biochemical exemplary standard by the light sensor.

10. The detective method according to claim 8, wherein the light sensor receives the first wavelength light that has passed through the biochemical sample, so as to obtain a plurality of the first measured value; and the detective method further comprising comparing a variation rate of the first measured values with a third reference value.

11. The detective method according to claim 8, wherein the light sensor receives the second wavelength light that has passed through the biochemical sample, so as to obtain a plurality of the second measured value; and the detective method further comprising comparing a variation rate of the second measured values with a fourth reference value.

12. The detective method according to claim 8, wherein response intensity of the light sensor to the second wavelength light is higher than to the first wavelength light.

13. The detective method according to claim 8, wherein the biochemical sample comprises a culture medium and a culture, and the culture is a cell, culture medium or protein.

14. The detective method according to claim 8, wherein the first reference value corresponds to density, concentration, quantity, area of a distribution region, pH or color of the biochemical sample in a first state, and the second reference value corresponds to density, concentration, quantity, area of a distribution region, pH or color of the biochemical sample in a second state.

15. The detective method according to claim 14, wherein a wavelength of the first wavelength light corresponds to the color of the biochemical sample in the first state, and a wavelength of the second wavelength light corresponds to the color of the biochemical sample in the second state.
